(19) United States
(12) Patent Application Publication
(10) Pub. No.: US 2011/0051883 A1
(43) Pub. Date: Mar. 3, 2011

(54) RACK SYSTEMS AND ASSEMBLIES FOR FUEL STORAGE

(75) Inventors: Ian McInnes, Puyallup, WA (US); William Bracey, West Orange, NJ (US); Robert L. Grubb, Ellicott City, MD (US); Jayant R. Bondre, Clarksville, MD (US); Miguel Manrique, Danville, CA (US); Prakash Narayanan, Columbia, MD (US); Raheel Haroon, Columbia, MD (US); Peter Shih, Ellicott City, MD (US)

(73) Assignee: TRANSNUCLEAR, INC., Columbia, MD (US)

(21) Appl. No.: 12/872,812

(22) Filed: Aug. 31, 2010

Related U.S. Application Data
(60) Provisional application No. 61/260,719, filed on Nov. 12, 2009.
(60) Provisional application No. 61/238,590, filed on Aug. 31, 2009.

(51) Int. Cl. G21C 3/34

(52) U.S. Cl. 376/462

(57) ABSTRACT

A rack assembly for nuclear fuel assemblies generally includes a frame assembly and a container assembly including a plurality of individual fuel containers designed to contain individual fuel assemblies, wherein the individual fuel containers are received within and supported by the frame assembly. The rack assembly further includes a shielding assembly including at least one of an inner shielding assembly comprising a substantially continuous shield between the individual fuel containers and an outer shielding assembly comprising a substantially continuous shield around at least a portion of the outer surfaces of the rack assembly. A rack storage system generally includes a plurality of rack assemblies.

### CROSS-REFERENCES TO RELATED APPLICATIONS

This application claims the benefit of U.S. Provisional Patent Application No. 61/238,590, filed on Aug. 31, 2009, and U.S. Provisional Patent Application No. 61/260,719, filed on Nov. 12, 2009, the disclosures of which are hereby expressly incorporated by reference.

### BACKGROUND

Racks are generally used to store fresh (new) nuclear fuel assemblies and spent (irradiated) nuclear fuel assemblies at nuclear reactor sites, for example, either in a dry storage area (for new fuel assemblies) or in a spent fuel pool area (for new and irradiated fuel assemblies). The dimensions of the fuel pool are generally standardized, depending upon the nuclear reactor type.

Previously designed rack assemblies are not optimized for efficient containment and storage of new and irradiated fuel assemblies. In that regard, the previously designed racks are complicated to fabricate because they use a significant number of weld points to create the frame assembly. Moreover, previously designed rack assemblies do not provide a substantially continuous neutron-absorbing shield between each compartment of the rack assembly to decrease the risk of criticality.

Thus, there exists a need for an improved rack assembly design that has a simplified design with a minimized number of weld points, yet a strong frame assembly for receiving and containing a plurality of individual fuel assemblies. Moreover, there exists a need for an improved rack assembly design having a continuous neutron-absorbing shield between each compartment of the rack assembly for improved criticality control.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In accordance with one embodiment of the present disclosure, a rack assembly for nuclear fuel assemblies is provided. The rack assembly generally includes a frame assembly and a container assembly including a plurality of individual fuel containers designed to contain individual fuel assemblies, wherein the individual fuel containers are received within and supported by the frame assembly. The rack assembly further includes a shielding assembly including at least one of an inner shielding assembly comprising a substantially continuous shield between the individual fuel containers and an outer shielding assembly comprising a substantially continuous shield around at least a portion of the outer surfaces of the rack assembly.

In accordance with another embodiment of the present disclosure, a rack assembly for nuclear fuel assemblies is provided. The rack assembly generally includes a frame assembly including top and bottom frame portions and a plurality of vertical frame supports and a container assembly including a plurality of individual fuel containers designed to contain individual fuel assemblies, wherein the individual fuel containers are received within and supported by the top and bottom frame portions of the frame assembly. The rack assembly further includes a shielding assembly including a substantially continuous shield between the individual fuel containers, wherein the shielding assembly is supported by the frame assembly.

In accordance with another embodiment of the present disclosure, a rack assembly for nuclear fuel assemblies is provided. The rack assembly generally includes a frame assembly including top and bottom frame portions and a plurality of structural support grids and a container assembly including a plurality of individual fuel containers designed to contain individual fuel assemblies, wherein the individual fuel containers are received within and supported by the frame assembly. The rack assembly further includes a shielding assembly including a substantially continuous shield between the individual fuel containers, wherein the shielding assembly is supported by the container assembly.

In accordance with another embodiment of the present disclosure, a rack storage system for nuclear fuel assemblies is provided. The rack storage system generally includes first and second rack assemblies, the first and second rack assemblies each comprising a frame assembly, a container assembly including a plurality of individual fuel containers designed to contain individual fuel assemblies, wherein the individual fuel containers are received within and supported by the frame assembly, and a shielding assembly including a substantially continuous shield between the individual fuel containers.

In accordance with another embodiment of the present disclosure, a rack storage system for nuclear fuel assemblies is provided. The rack storage system generally includes at least one first rack assembly, the first rack assembly comprising a frame assembly, a container assembly including a plurality of individual fuel containers designed to contain individual fuel assemblies, wherein the individual fuel containers are received within and supported by the frame assembly, and a shielding assembly including a substantially continuous shield between the individual fuel containers. The rack storage system further includes at least one second rack assembly, the second rack assembly comprising a frame assembly and a container assembly including a plurality of individual fuel containers designed to contain individual fuel assemblies, wherein the second rack assembly does not include a shielding assembly.

In accordance with another embodiment of the present disclosure, the shielding assembly of the rack assembly includes a neutron-shielding material for criticality control.

In accordance with another embodiment of the present disclosure, the shielding assembly of the rack assembly includes material selected from the group consisting of boron carbide-aluminum metal matrix composites, natural or enriched boron aluminum alloy, boron stainless steel alloy, aluminum clad boron carbide cements, BORAI®neutron absorber material, manufactured by CERADYNE, INC., aluminum, and stainless steel.

In accordance with another embodiment of the present disclosure, the inner shielding of the rack assembly is supported by the frame assembly.

In accordance with another embodiment of the present disclosure, the inner shielding of the rack assembly is supported by the container assembly.

In accordance with another embodiment of the present disclosure, the outer shielding of the rack assembly is supported by at least one of the container assembly and the frame assembly.

In accordance with another embodiment of the present disclosure, the inner shielding of the rack assembly comprises a plurality of intersecting plates configured along the x- and y-axes of the rack assembly. In accordance with another embodiment of the present disclosure, the intersecting inner plates are configured to interface with one another without substantially interrupting the substantially continuous shield between the individual fuel containers. In accordance with another embodiment of the present disclosure, the intersecting inner plates are slotted for interfacing with one another.

In accordance with another embodiment of the present disclosure, the inner shielding assembly comprises two plates between each of the individual fuel containers.

In accordance with another embodiment of the present disclosure, the outer shielding assembly comprises a plurality of plates configured along the z-axis of the rack assembly.

In accordance with another embodiment of the present disclosure, the outer shielding assembly is secured in the z-axis of the rack assembly by connection bands.

In accordance with another embodiment of the present disclosure, the frame assembly includes first and second frame portions, each of the first and second frame portions comprising a plurality of compartments for receiving individual fuel containers, wherein the first frame portion is spaced a predetermined distance from the second frame portion.

In accordance with another embodiment of the present disclosure, the frame assembly includes one or more support grids intermediate the first and second frame portions. In accordance with another embodiment of the present disclosure, the support grids have apertures that align with the plurality of compartments in the first and second frame portions.

In accordance with another embodiment of the present disclosure, the first and second frame portions include gap cells between adjacent compartments for receiving at least a portion of the shielding assembly.

### DESCRIPTION OF THE DRAWINGS

The foregoing aspects and many of the attendant advantages of this disclosure will become more readily appreciated as the same become better understood by reference to the following detailed description, when taken in conjunction with the accompanying drawings, wherein:

FIG. 1 is a top view of a rack storage system for a spent fuel pool area in accordance with one embodiment of the present disclosure;

FIG. 2 is a perspective view of a first rack assembly for use in the rack storage system of FIG. 1, in accordance with one embodiment of the present disclosure;

FIG. 3 is a perspective view of a frame assembly for the first rack assembly of FIG. 2;

FIG. 4 is an exploded view of a first rack assembly of FIG. 2, including an outer shielding assembly;

FIG. 5 is a perspective view of an inner shielding assembly of the first rack assembly of FIG. 2;

FIG. 6 is an exploded view of the inner shielding assembly of FIG. 5;

FIG. 7 is a perspective view of a second rack assembly for use in, for example, the rack storage system of FIG. 1, in accordance with another embodiment of the present disclosure;

FIG. 8 is a perspective view of a frame assembly for the first rack assembly of FIG. 7;

FIG. 9 is an exploded view of a first rack assembly of FIG. 7, including an outer shielding assembly;

FIG. 10 is a perspective view of a first rack assembly for use in the rack storage system of FIG. 1, in accordance with another embodiment of the present disclosure;

FIG. 11 is a perspective view of a frame assembly for the first rack assembly of FIG. 10; and

FIG. 12 is an exploded view of a first rack assembly of FIG. 10.

### DETAILED DESCRIPTION

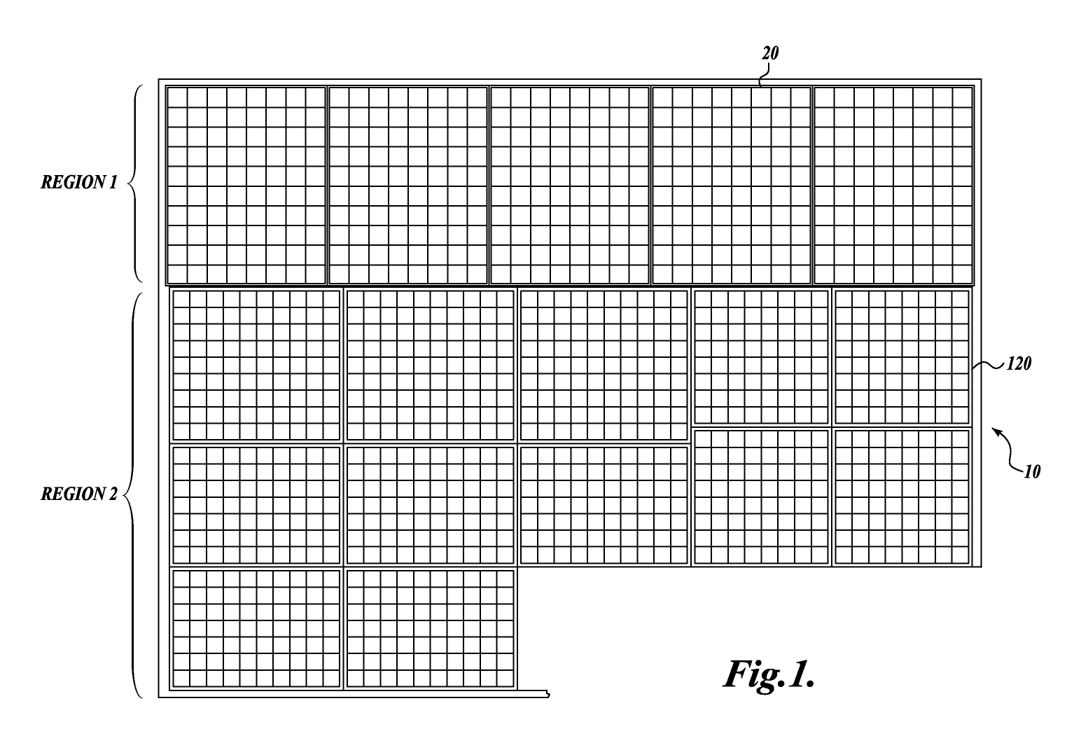

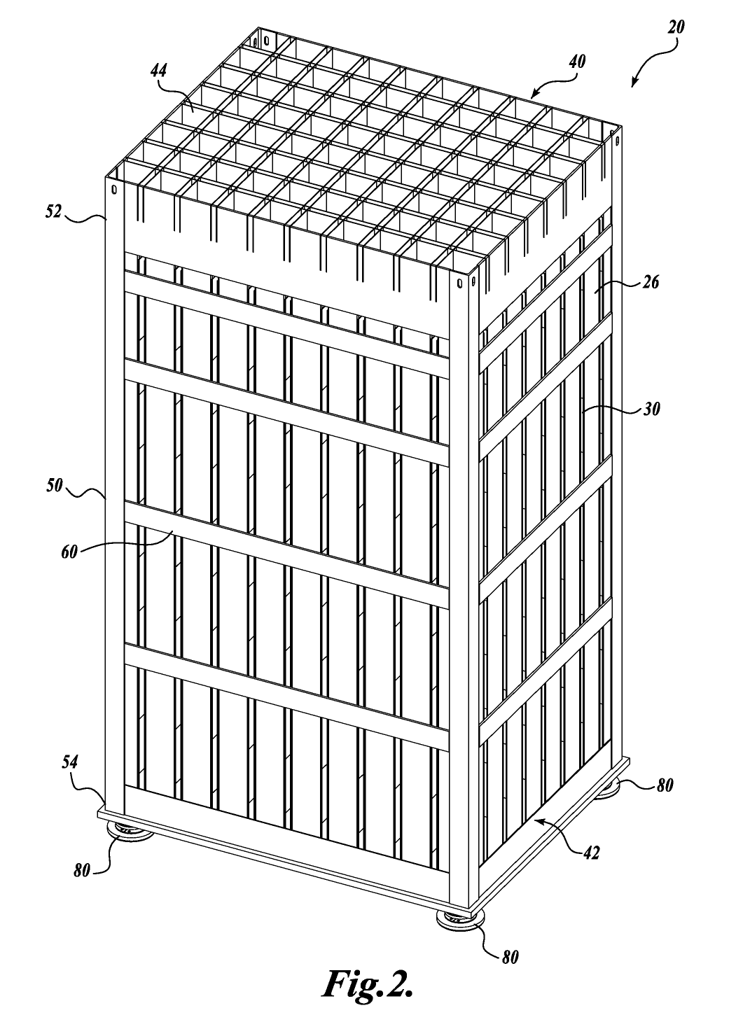

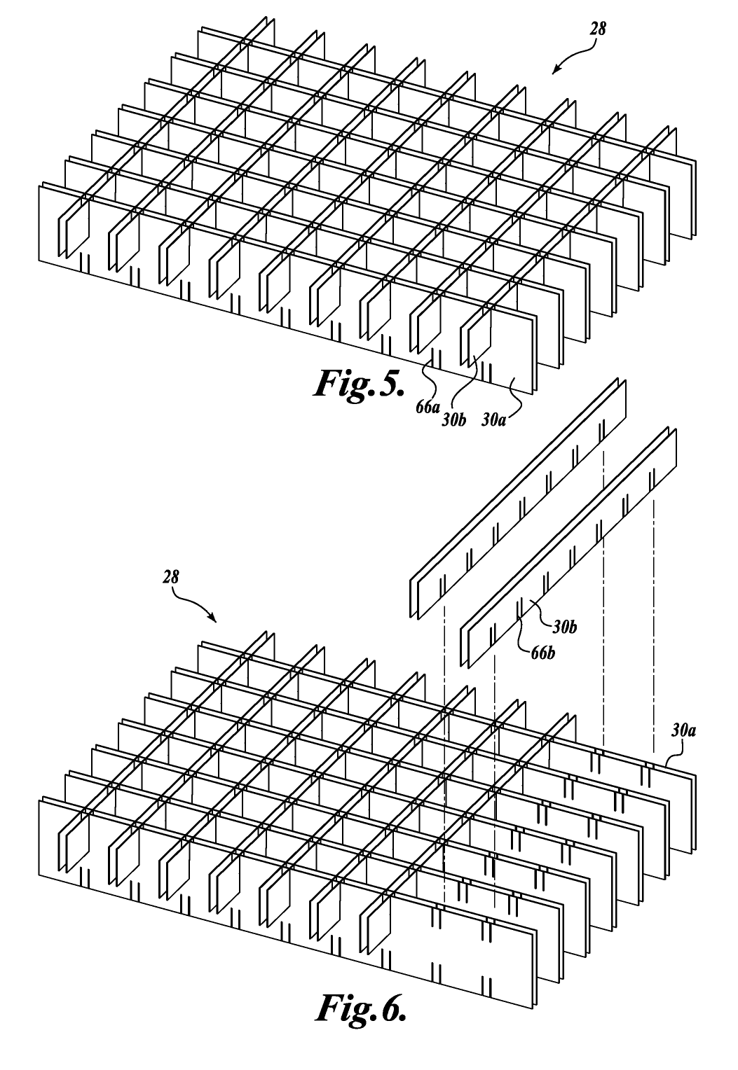

A rack storage system 10 for a spent fuel pool area constructed in accordance with one embodiment of the present disclosure may be best understood by referring to FIG. 1. The rack storage system 10 includes two regions, Region 1 and Region 2, for receiving respective first and second rack assemblies 20 and 120 (see FIGS. 2 and 5).

The first rack assembly 20, designed for use in Region 1, generally includes compartments that are configured for holding high reactivity nuclear fuel assemblies, for example, fresh nuclear fuel assemblies. The second rack assembly 120, designed for use in Region 2, generally includes compartments that are closer together for holding low reactivity nuclear fuel assemblies, for example, spent nuclear fuel assemblies. The first rack assembly 20 compartments are generally larger in size than the second rack assembly 120 compartments because the Region 1 rack assemblies 20 are designed to accommodate neutron shielding materials, which are not required in Region 2 rack assemblies 120. It should be appreciated, however, that the smaller Region 2 rack assembly 120 may also hold fresh fuel if configured in a checkerboard configuration, such that fresh fuel assemblies are not contained in adjacent compartments.

It should be appreciated that terms used in the specification defining the orientations of the rack assemblies 20 and 120, such as “top”, “bottom”, “vertical”, and “horizontal” are not intended to be limiting. These terms are used to simplify the description of the illustrated rack assemblies; however, it should be appreciated that the rack assemblies may be used in other orientations besides the illustrated orientations.

Although the rack storage system 10 is shown in a specific configuration for a spent fuel pool area in FIG. 1, it should be appreciated that other rack storage systems, dimensions, and configurations are also within the scope of the present disclosure. For example, suitable systems may also be configured for a dry storage area having a different system configuration than a spent fuel pool area. In addition, individual rack assemblies 20 and 120 may be configured having various numbers of compartments. As non-limiting examples, in the illustrated embodiment of FIG. 1, the second rack assemblies 120 are shown as having 9×10, 8×8, and 7×10 compartment configurations.

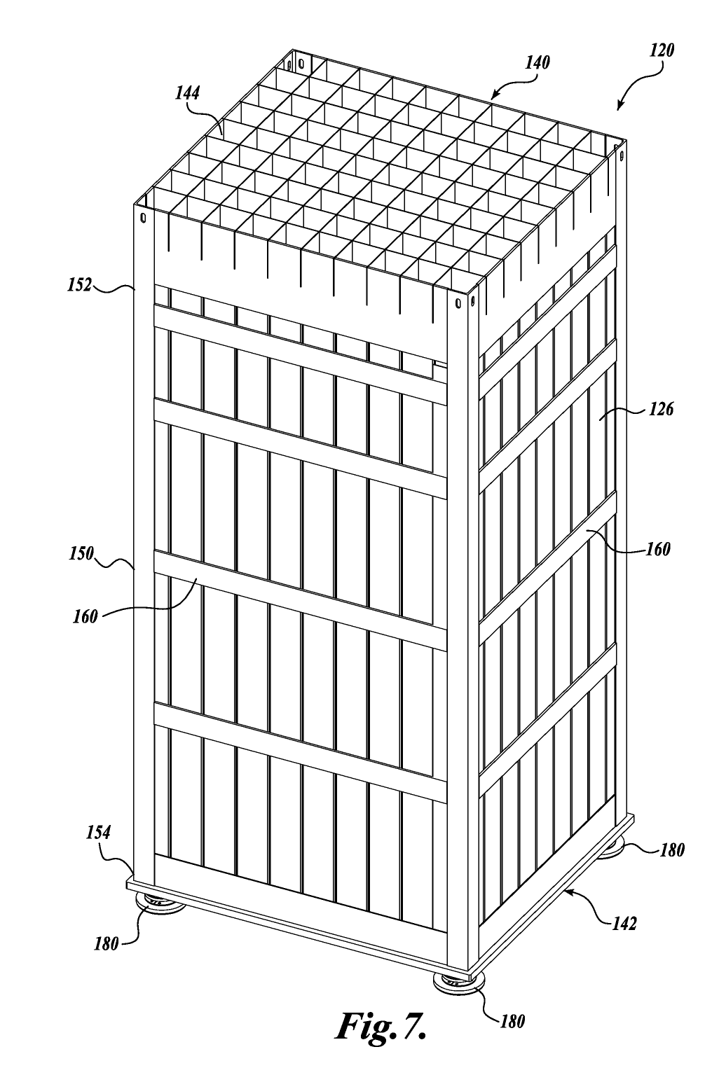

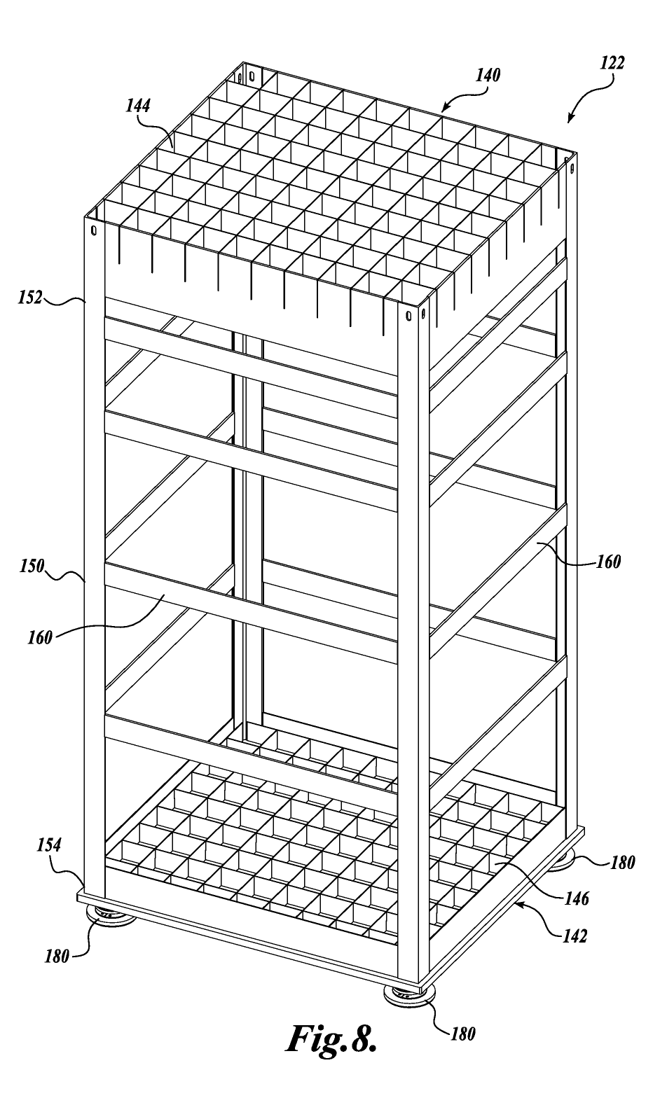

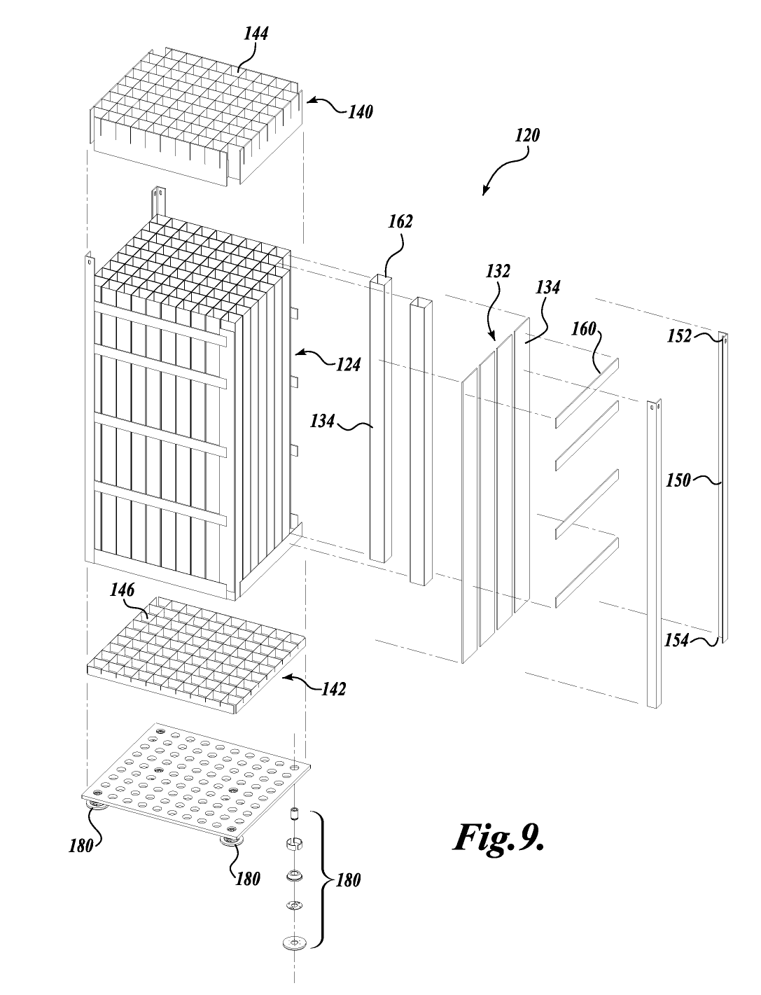

A first rack assembly 20 designed for use in Region 1 will now be described in greater detail with reference to FIGS. 2-6. A second rack assembly 120 designed for use in Region 2 will be described in greater detail below with reference to FIGS. 7-9.

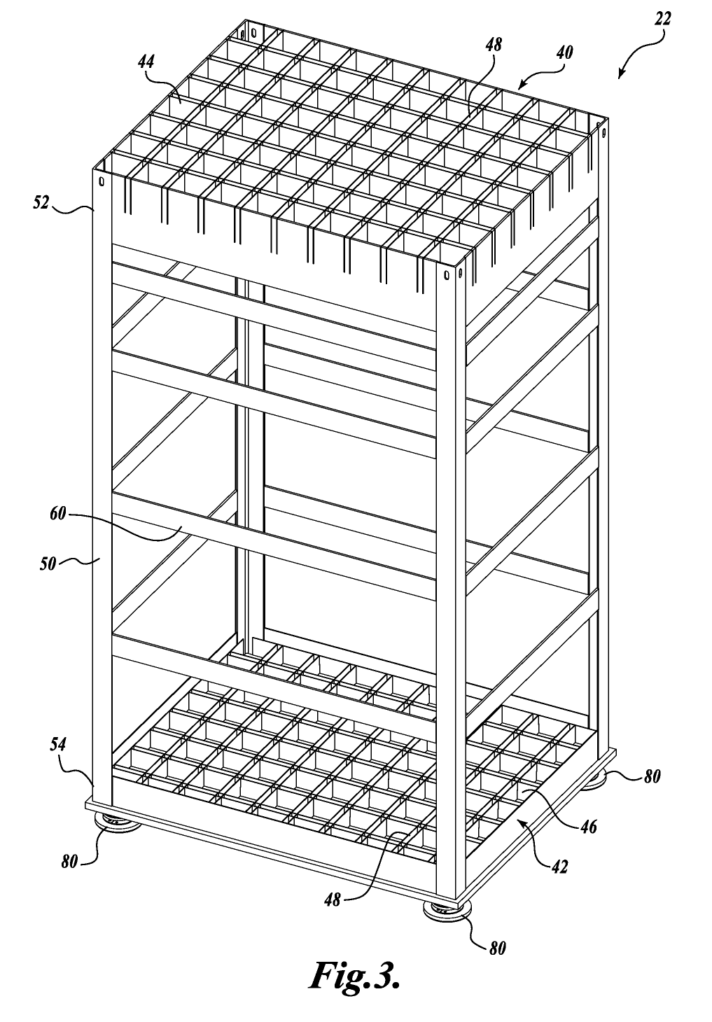

Referring to FIGS. 2-4, the first rack assembly 20 includes a frame assembly 22 (see, in particular, FIG. 3 for a skeleton view of the frame assembly 22), a container assembly 24 including a plurality of individual fuel containers 26, shown as tubes, for receiving nuclear fuel assemblies (not shown) in a desired orientation and spacing from one another, and a shielding assembly including at least one of an inner shielding assembly 28 and an outer shielding assembly 32 for maintaining criticality control within the rack assembly 20 and within the rack storage system 10.

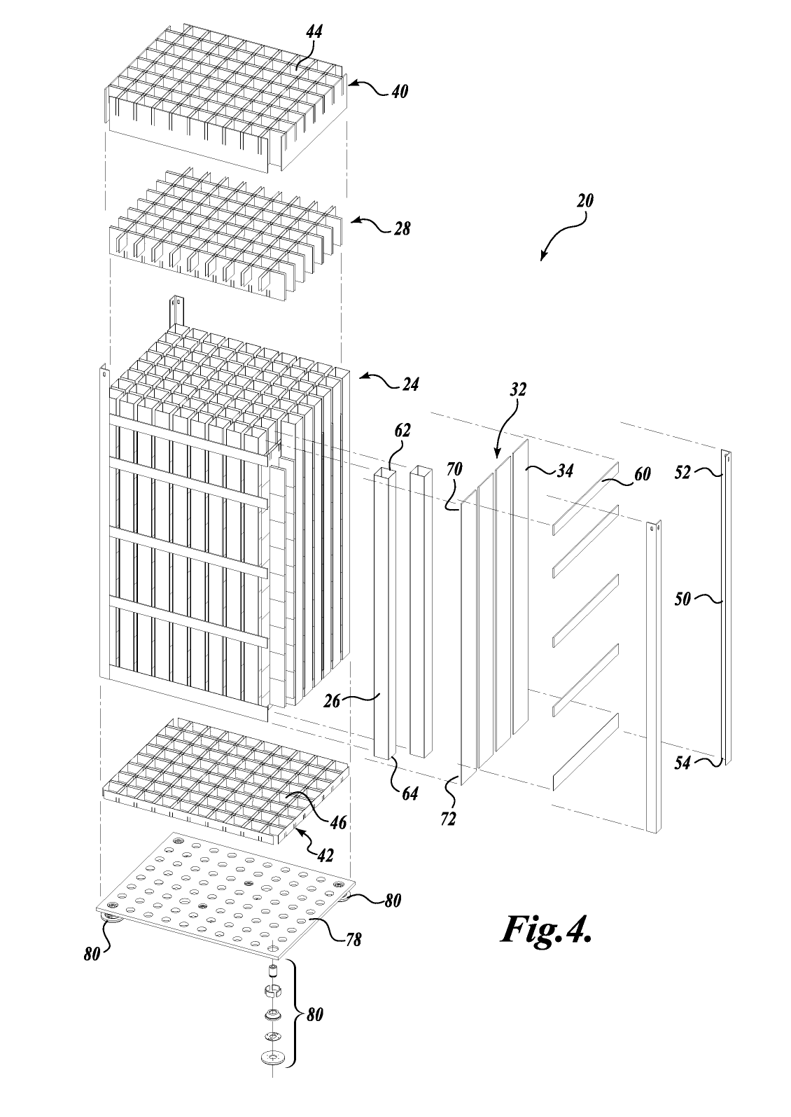

Referring to FIG. 3, the frame assembly 22 will now be described in greater detail. The frame assembly 22 provides a frame for the containment of the container assembly 24 (see FIG. 4). In the illustrated embodiment, the frame assembly 22 is an external frame assembly 22, in that its components are primarily located on the exterior surfaces of the rack assembly 20. In contrast, the container assembly 24 is primarily on the interior of the rack assembly 30. As non-limiting examples, the components of the frame assembly 22 may be constructed from metal, such as aluminum, stainless steel, and alloys thereof.

The frame assembly 22 includes first and second frame portions 40 and 42, wherein each of the first and second frame portions 40 and 42 include grid structures having apertures defining respective pluralities of compartments 44 and 46. Both the first and second frame portions 40 and 42 are configured for receiving and supporting the first and second end portions 62 and 64 of the individual fuel containers 26 (see FIG. 4). In that regard, the first and second frame portions 40 and 42 maintain the individual fuel containers 26 in a grid orientation and therefore maintain suitable spacing between the individual fuel containers 26. In the illustrated embodiment, the first frame portion 40 is a top frame portion, and the second frame portion 42 is a bottom frame portion.

As a non-limiting example, the first and second frame portions 40 and 42 in the illustrated embodiment have grid structures resembling an egg-crate design that defines respective pluralities of discrete compartments 44 and 46. The egg-crate designs are configured to be stackable when used in conjunction with an inner shielding assembly 28, as described in greater detail below. However, it should be appreciated that other designs are also within the scope of the present disclosure.

It should be appreciated that the second frame portion 42 may be configured to have compartments 46 that taper from a first cross-sectional area to a smaller second cross-sectional area. With such a tapering cross-sectional area, fuel assemblies (not shown) or their containers 26 cannot be removed or cannot fall through the compartments 46 in the second frame portion 42. On the other hand, the compartments 44 in the first frame portion 40 may have a constant cross-sectional area, such that fuel assemblies (not shown) can be inserted and/or removed from the compartments 44 with ease. It should be appreciated that the containers 26 and the compartments 44 and 46 of the respective first and second frame portions 40 and 42 generally have open ends so that water can freely flow through the containers 26 when the rack assembly 20 is in a spent fuel pool area.

As seen in the illustrated embodiment of FIGS. 3 and 4, the discrete compartments 44 and 46 of the first and second frame portions 40 and 42 are surrounded by gap cells 48 which allow for suitable spacing between fresh fuel assemblies to prevent criticality. The gap cells 48 of the first and second frame portions 40 and 42 may further receive and support inner shielding plates 30 of the inner shielding assembly 28, such that the inner shielding assembly 28 is supported by the frame assembly 22. In that regard, at least a portion of inner shielding plates 30 may be positioned to interface with the gap cells 48 of the first and second frame portions 40 and 42 to form discrete and shielded longitudinal compartments for the individual fuel containers 26. The shielded longitudinal compartments may extend the length of the first rack assembly 20 from the first frame portion 40 to the second frame portion 42 (see FIG. 4). The properties of the inner shielding plates 30 and the configuration of the inner shielding plates 30 in the gap cells 48 and extending between the first and second frame portions 40 and 42 will be described in greater detail below.

The frame assembly 22 further includes frame supports 50, which extend longitudinally between the first and second frame portions 40 and 42. The frame supports 50 allow the first and second frame portions 40 and 42 to be spaced a predetermined distance from one another. In the illustrated embodiment, the frame supports 50 extend vertically between the first (top) and second (bottom) frame portions 40 and 42 at each of the four corner edges of the rack assembly 20. In that regard, a first end 52 of the frame support 50 is coupled to the first frame portion 40 and a second end 54 of the frame support 50 is coupled to the second frame portion 42. However, it should be appreciated that other suitable frame support configurations are also within the scope of the present disclosure. For example, the frame supports need not be corner supports, and may extend between the first and second frame portions 40 and 42 along the sides of the rack assembly 20, and not necessarily at the corner edges.

In addition, the frame assembly 22 includes connection bands 60 that extend between adjacent frame supports 50. The connection bands 60 provide reinforcement to the rack assembly 20, but require minimum weld or connection points in the overall fabrication of the frame assembly 22. In the illustrated embodiment, the bands 60 extend horizontally between adjacent vertical frame supports 50. However, it should be appreciated that other suitable band configurations are also within the scope of the present disclosure. For example, suitable bands may extend crosswise from the first end 52 (e.g., the top end) of a first frame support 50 to the second end 54 (e.g., the bottom end) of a second frame support 50. The advantage of using such bands 60 is to improve the integrity of the frame assembly 22 and the overall rack assembly 20, as well as to support and secure the outer shielding assembly 32 so that outer shielding plates 34 may be positioned to enclose the outer walls of the first rack assembly 20, as described in greater detail below.

Referring to FIG. 4, the container assembly 24 including a plurality of individual fuel containers 26 will now be described in greater detail. These individual fuel containers 26 are designed to hold the individual fuel assemblies (not shown) in the first rack assembly 20. As seen in FIG. 4, the individual fuel containers 26 are configured to be inserted into the individual compartments 44 of the first frame portion 40 and extend to the individual compartments 46 in the second frame portion 42. In the illustrated embodiment, the individual fuel containers 26 are tubular having a square cross-sectional shape. However, it should be appreciated that other tubular containers having other cross-sectional shapes, for example, including, but not limited to, round, oval, or polygonal, are also within the scope of the present disclosure.

In the illustrated embodiment, the individual fuel containers 26 are configured to extend the full height of the assembly 20, such that a first end 62 of the container 26 is received by the first compartment 44 of the first frame portion 40 and a second end 64 of the container is received by the second compartment 46 of the second frame portion 42. By extending the full height of the assembly 20, the individual fuel containers 26 can be contained in the frame assembly 22 without requiring additional frame support members besides the first and second frame portions 40 and 42 and the frame supports 50. Using this construction, the rack assembly 20 relies on the rigidity of the individual fuel containers 26 to structurally complement the frame assembly 22.

As non-limiting examples, the individual fuel containers 26 may be constructed from metal, such as aluminum, stainless steel, and alloys thereof. In one embodiment, the individual fuel containers 26 are manufactured from extruded aluminum. In another embodiment, the individual fuel containers 26 are manufactured by welding individual plates together. In the illustrated embodiment, the individual fuel containers 26 are maintained in a substantially vertical orientation by being received in corresponding individual compartments in the first and second frame portions 40 and 42. However, it should be appreciated that other orientations, such as a horizontal orientation, are also within the scope of the present disclosure.

Referring to FIG. 4, the shielding assembly will now be described in greater detail. The shielding assembly generally includes an inner shielding assembly 28 and an outer shielding assembly 32. In the illustrated embodiment of FIGS. 2-6, the inner shielding assembly 28 includes inner shielding plates 30, and the outer shielding assembly 32 includes outer shielding plates 34. Suitable shielding plates, whether inner 30 or outer 32, may be neutron-shielding and/or neutron-absorbing material for criticality control. Suitable exemplary materials include, but are not limited to, boron carbide-aluminum metal matrix composites, natural or enriched boron aluminum alloy, boron stainless steel alloy, aluminum clad boron carbide cements, BORAI® neutron absorber material, manufactured by CERADYNE, INC., aluminum, stainless steel, and other similar materials.

As discussed above, the gap cells 48 in the first and second frame portions 40 and 42 are configured to receive and/or interface with the inner shielding plates 30. In the illustrated embodiment, the inner plates 30 extend substantially horizontally through the assembly 20 along respective x- and y-axes of the assembly to align with the gap cells 48 in the first and second frame portions 40 and 42. Such shielding plates create a shield between each individual fuel container 26 of the rack assembly 120 for criticality control.

Referring now to FIGS. 5 and 6, the inner shielding assembly 28 will be described in greater detail. In that regard, the intersections of adjacent horizontal x- and y-axes inner plates 30 will now be described. X-axis inner plates are labeled 30a, and y-axis inner plates are labeled 30b. Intersecting x- and y-axes inner plates 30a and 30b are configured to interface with one another to provide a continuous shield between individual fuel containers 26. In the illustrated embodiment, the inner plates 30a and 30b include slots 66a and 66b so that perpendicularly oriented inner plates 30a and 30b can interface at their respective slots 66a and 66b and stack up upon each other to provide a substantially continuous shield in the horizontal z- and y-axes. Moreover, the grids of plates are configured to stack on top of each other to provide a substantially continuous shield along the vertical z-axis. Such stacking results in a substantially continuous shield between individual fuel containers 26 to effectively absorb neutrons and prevent criticality.

In the illustrated embodiment, the inner shielding assembly 28 includes two plates for increased shielding. In that regard, each of the inner shielding plate 30a and 30b has two layers of shielding material, the layers being spaced a predetermined distance from one another. Such distance may be the same width as the width of the gap cells 48 in the first and second frame portions 40 and 42.

In previously designed racks, the individual shielding plates are rigidly attached or fastened to a portion of the sides of the individual fuel containers. For example, see U.S. Pat. No. 5,361,281, issued to Porowski, the disclosure of which is expressly incorporated by reference. Because the shielding plates are rigidly attached to only a portion of the sides of the individual fuel containers, it is not possible to provide a continuous shield, like the shield provided by the intersecting and stacking inner plates 30 of the present disclosure. While such rigidly attached plates provide some neutron shielding protection, the previously designed plates do not provide a continuous shield to effectively prevent criticality in the rack assembly.

In addition to inner plates 30, an outer shielding assembly 32 including outer shielding plates 34 may be positioned around the outer perimeter of the rack assembly 20 for enhanced criticality properties. In the illustrated embodiment, the outer shielding plates 34 are positioned in a substantially vertical orientation along the outer perimeter of the rack assembly 20. In one embodiment, the outer plates 34 include neutron-shielding and/or neutron-absorbing material for criticality control.

It should be appreciated that, in one embodiment, the outer plates 34 are designed to extend the full height of the assembly 20 from the first frame portion 40 to the second frame portion 42. However, their width may vary depending on the manufacturing parameters of the rack assembly 20. Moreover, it should be appreciated that the outer plates 34 may, like the inner plates 30, have two layers of shielding material.

Returning to FIG. 1, the illustrated embodiment shows a rack storage system for a spent fuel pool area including first and second rack assemblies 20 (Region 1) and 120 (Region 2). When a side of a Region 1 assembly 20 faces a wall W of the fuel pool, the assembly 20 may be configured without an outer plate 34 on the side facing the pool wall W because neutron shielding is not required at the pool wall W.

Referring to FIG. 4, the outer plates 34 and the individual fuel containers 26 can be maintained in their substantially vertical orientation by being contained between the outer walls of the first and second frame portions 40 and 42 and the individual fuel containers 26 positioned along the outer perimeter of the rack assembly 20. In that manner, the outer plates 34 may extend at least from the first frame portion 40 to the second frame portion 42, such that the first end 70 of the outer plate 34 can be received within a compartment 44 and the first frame portion 40 and the second end 72 of the outer plate 34 can be received within a compartment 46 the second frame portion 40. As mentioned above, connection bands 60 are attached to the frame supports 50 to hold the outer plates 34 in place. In the illustrated embodiment, the connection bands 60 are horizontally oriented between adjacent frame supports 50.

By using connection bands 60 and first and second frame portions 40 and 42 to hold the individual fuel containers 26 and outer plates 34 in place, the rack assembly 20 has strong frame assembly 22 integrity, but can be fabricated with minimal weld points.

Still referring to FIG. 4, the base 78 and feet 80 of the rack assembly 20 are shown. The feet 80 are designed to be adjustable to accommodate an uneven standing surface, for example, on the bottom of the pool upon which the rack assembly 20 may stand.

Referring to FIGS. 7-12, other embodiments of rack assemblies are shown. Referring to FIGS. 7-9, an embodiment of a rack assembly 120 designed for Region 2 is shown. This embodiment is substantially similar to the embodiment 20 described above. In this embodiment, however, the first and second frame portions 140 and 142 are not configured with gap cells between the walls of the first and second frame portions 140 and 142 defining the individual compartments 144 and 146. Moreover, the rack assembly 120 of the present embodiment does not include an inner shielding assembly.

Even though the rack assembly 120 does not include an inner shielding assembly, it may include an outer shielding assembly, like the Region 1 rack assembly 20. In that regard, the Region 2 rack assembly 120 may include a plurality of outer plates 134 positioned around the outer perimeter of the assembly 120 for enhanced criticality properties. Returning to FIG. 1, the illustrated embodiment shows the individual rack assemblies 20 (Region 1) and 120 (Region 2) in the pool configuration. Like the Region 1 assemblies 20, Region 2 assemblies 120 do not require an outer plate on the sides facing the pool walls W.

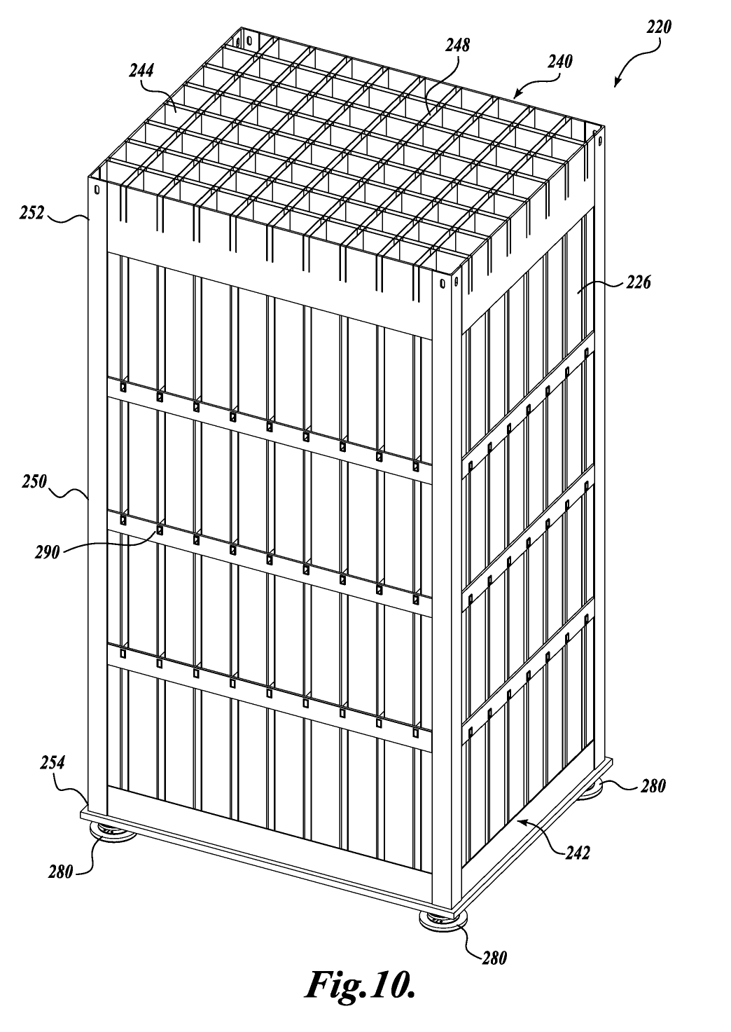

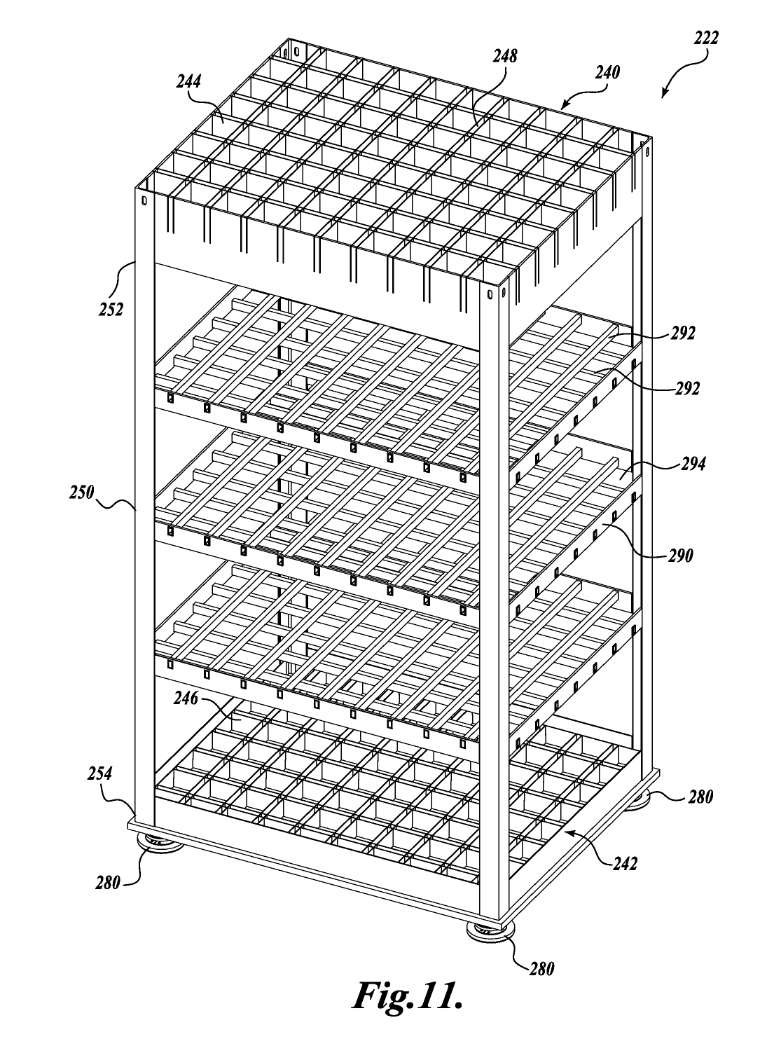

Referring to FIGS. 10-12, another embodiment of a rack assembly 220 designed for Region 1 is shown. Like the rack assembly 120, this embodiment is also substantially similar to the embodiment 20 described above. In this embodiment, however, the frame assembly 222 of the rack assembly 220 includes a plurality of support grids 290 to provide enhanced structural support, for example, to withstand a seismic event (see FIG. 11). Moreover, the inner shielding assembly is not a stand alone system, as seen in rack assembly 20 shown in FIGS. 2-6. In contrast, the inner shielding assembly is incorporated into the container assembly, by being affixed to the surfaces of the individual fuel containers 226.

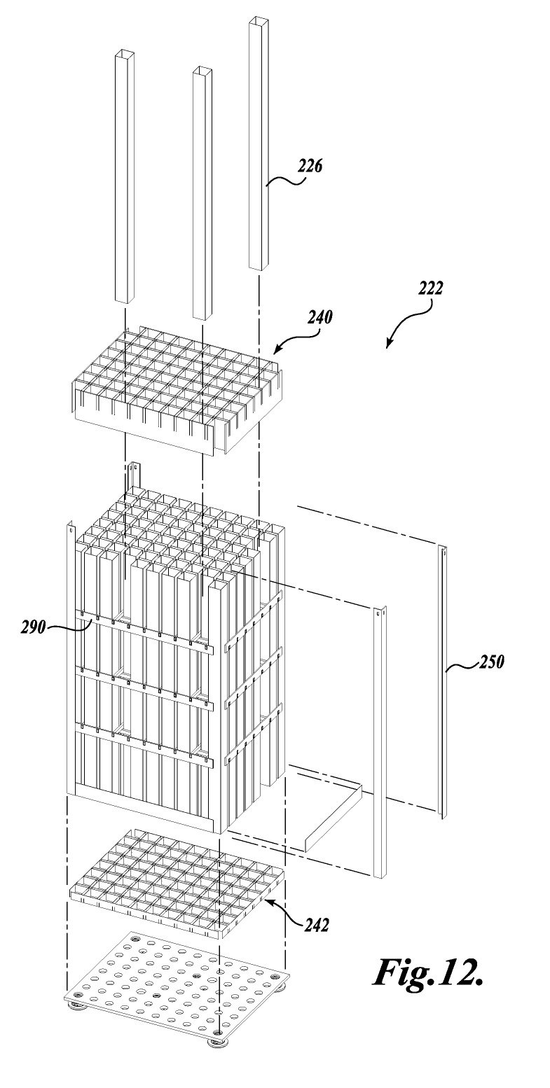

Referring to FIGS. 11 and 12, the support grids 290 are coupled to the frame supports 250 intermediate the first and second frame portions 240 and 242. In the illustrated embodiment, three support grids 290 are shown; however, it should be appreciated that any number of support grids 290 is within the scope of the present disclosure. Each of the support grids 290 are configured with x-axis and z-axis separators 292 that create a plurality of apertures 294. Suitable separators 292 may be round, square, rectangular solids or hollow, or of any other suitable configuration. The apertures 294 align with the compartments 244 and 246 in the first and second frame portions 240 and 242 to hold the fuel containers 226 in place. Because of this alignment, the support grids 290 provide enhanced structural support to the frame assembly. Specifically, the support grids 290 are designed to receive the load from the containers 226, for example, during a seismic event.

Because the support grids 290 do not allow for a substantially continuous inner shielding assembly, as seen in the illustrated embodiment of FIGS. 2-6, the inner shielding assembly is incorporated into the containers 226, such that the inner shielding assembly is supported by the container assembly. In that regard, each container 226 includes shielding material on all surfaces, creating a continuous inner shielding assembly around the containers 226. Therefore, because there is shielding material on adjacent surfaces of adjacent containers 226, there is also a double layer of shielding material between adjacent fuel containers 226, similar to the illustrated embodiment of FIGS. 2-6.

Like the other embodiments, the rack assembly 220 may further include a plurality of outer plates (not shown) positioned around the outer perimeter of the assembly 220 for enhanced criticality properties. Moreover, the rack assembly 220 may have a layer of shielding material on the surface of the containers 226 that face outwardly from the container assembly. Therefore, the outer shielding assembly may be supported by either the container assembly or the frame assembly or both.

While illustrative embodiments have been illustrated and described, it will be appreciated that various changes can be made therein without departing from the spirit and scope of the disclosure.

1. A rack assembly for nuclear fuel assemblies, the rack assembly comprising:
(a) a frame assembly;
(b) a container assembly including a plurality of individual fuel containers designed to contain individual fuel assemblies, wherein the individual fuel containers are received within and supported by the frame assembly; and
(c) a shielding assembly including at least one of an inner shielding assembly comprising a substantially continuous shield between the individual fuel containers and an outer shielding assembly comprising a substantially continuous shield around at least a portion of the outer surfaces of the rack assembly.

2. The rack assembly of claim 1, wherein the shielding assembly includes a neutron-shielding material for criticality control.

3. The rack assembly of claim 1, wherein the shielding assembly includes material selected from the group consisting of boron carbide-aluminum metal matrix composites, natural or enriched boron aluminum alloy, boron stainless steel alloy, aluminum clad boron carbide cements, BORAI®neutron absorber material, aluminum, and stainless steel.

4. The rack assembly of claim 1, wherein the inner shielding assembly is supported by the frame assembly.

5. The rack assembly of claim 1, wherein the inner shielding assembly is supported by the container assembly.

6. The rack assembly of claim 1, wherein the outer shielding assembly is supported by at least one of the container assembly and the frame assembly.

7. The rack assembly of claim 1, wherein the inner shielding assembly comprises a plurality of intersecting plates configured along the x- and y-axes of the rack assembly.

8. The rack assembly of claim 7, wherein intersecting inner plates are configured to interface with one another without substantially interrupting the substantially continuous shield between the individual fuel containers.

9. The rack assembly of claim 7, wherein intersecting inner plates are slotted for interfacing with one another.

10. The rack assembly of claim 1, wherein the inner shielding assembly comprises two plates between each of the individual fuel containers.

11. The rack assembly of claim 1, wherein the outer shielding assembly comprises a plurality of plates configured along the z-axis of the rack assembly.

12. The rack assembly of claim 11, wherein the outer shielding assembly is secured in the z-axis of the rack assembly by connection bands.

13. The rack assembly of claim 1, wherein the frame assembly includes first and second frame portions, each of the first and second frame portions comprising a plurality of compartments for receiving individual fuel containers, wherein the first frame portion is spaced a predetermined distance from the second frame portion.

14. The rack assembly of claim 13, wherein the frame assembly includes one or more support grids intermediate the first and second frame portions.

15. The rack assembly of claim 13, wherein the support grids have apertures that align with the plurality of compartments in the first and second frame portions.

16. The rack assembly of claim 13, wherein the first and second frame portions include gap cells between adjacent compartments for receiving at least a portion of the shielding assembly.

17. A rack assembly for nuclear fuel assemblies, the rack assembly comprising:
(a) a frame assembly including top and bottom frame portions and a plurality of vertical frame supports;
(b) a container assembly including a plurality of individual fuel containers designed to contain individual fuel assemblies, wherein the individual fuel containers are received within and supported by the top and bottom frame portions of the frame assembly; and
(c) a shielding assembly including a substantially continuous shield between the individual fuel containers, wherein the shielding assembly is supported by the frame assembly.

18. A rack assembly for nuclear fuel assemblies, the rack assembly comprising:
(a) a frame assembly including top and bottom frame portions and a plurality of structural support grids;
(b) a container assembly including a plurality of individual fuel containers designed to contain individual fuel assemblies, wherein the individual fuel containers are received within and supported by the frame assembly; and
(c) a shielding assembly including a substantially continuous shield between the individual fuel containers, wherein the shielding assembly is supported by the container assembly.

19. A rack storage system, comprising:
first and second rack assemblies, the first and second rack assemblies each comprising a frame assembly, a container assembly including a plurality of individual fuel containers designed to contain individual fuel assemblies, wherein the individual fuel containers are received within and supported by the frame assembly, and a shielding assembly including a substantially continuous shield between the individual fuel containers.

20. A rack storage system, comprising:
(a) at least one first rack assembly, the first rack assembly comprising a frame assembly, a container assembly including a plurality of individual fuel containers designed to contain individual fuel assemblies, wherein the individual fuel containers are received within and supported by the frame assembly, and a shielding assembly including a substantially continuous shield between the individual fuel containers; and
(b) at least one second rack assembly, the second rack assembly comprising a frame assembly and a container assembly including a plurality of individual fuel containers designed to contain individual fuel assemblies, wherein the second rack assembly does not include a shielding assembly.
